(19) United States
(12) Patent Application Publication
(10) Pub. No.: US 2022/0198200 A1
(43) Pub. Date: Jun. 23, 2022

(54) ROAD LANE CONDITION DETECTION WITH LANE ASSIST FOR A VEHICLE USING INFRARED DETECTING DEVICE

(71) Applicant: Continental Automotive Systems, Inc., Auburn Hills, MI (US)

(72) Inventor: Jacob Andrew LaPonse, Waterford, MI (US)

(73) Assignee: Continental Automotive Systems, Inc., Auburn Hills, MI (US)

(21) Appl. No.: 17/247,751

(22) Filed: Dec. 22, 2020

(51) Int. Cl. G06K 9/00; H04N 5/33; G01S 7/481; G01S 17/931; G01S 17/89

(52) U.S. Cl. CPC G06K 9/00798; H04N 5/33; G01J 5/0853; G01S 17/931; G01S 17/89; G01S 7/481

(57) ABSTRACT

A system is provided for a vehicle having a front, a rear, a right side and a left side. The system includes an infrared detecting device mounted on the front of the vehicle. The infrared detecting device is constructed and arranged to 1) detect variations in road temperature and 2) detect heat tracks left on a road lane by preceding vehicles. A control unit is mounted in the vehicle and is connected to the infrared detecting device so as to process signals received from the infrared detecting device, the control unit being constructed and arranged 1) to predict road conditions based on the variations in road temperature detected by the infrared detecting device or 2) to predict road lane location, based on a path defined by the heat tracks detected by the infrared detecting device.

### FIELD

This invention relates to Advanced Driver-Assistance Systems (ADAS) and, in particular, to a system that detects road lane conditions and provides vehicle lane assist using an infrared detecting device.

### BACKGROUND

ADAS technology has come a long way over the years and has saved multiple lives in the process. However, such systems can be improved further, particularly during driving at night. Although there is significantly less traffic on the road at night (60 percent less), 40 percent of all fatal car accidents occur at night. Lane conditions at night are some of the hardest things to gauge as a driver. Patent Application Publication US2018/0141561 A1 discloses a system, having a conventional camera, for detecting and assessing reflections of light on a road to determine road conditions. However, such systems may have difficulty accessing road conditions at night when visible light is at a minimum.

Furthermore, conventional lane assist systems for vehicles use conventional cameras to detect road lane markers typically painted on the road. However, during night driving with poor lighting, or when the lane markings lack sufficient paint, these systems may be unable to be detect the lane markings.

Thus, there is a need to provide an improved ADAS system using an infrared detecting device to detect road conditions and that can aid in the lane assist function.

### SUMMARY

An objective of the invention is to fulfill the need referred to above. In accordance with the principles of an embodiment, this objective is achieved by a system for a vehicle having a front, a rear, a right side and a left side. The system includes an infrared detecting device mounted on the front of the vehicle. The infrared detecting device is constructed and arranged to 1) detect variations in road temperature and 2) detect heat tracks left on a road lane by preceding vehicles. A control unit is mounted in the vehicle and is connected to the infrared detecting device so as to process signals received from the infrared detecting device. The control unit is constructed and arranged 1) to predict road conditions based on the variations in road temperature detected by the infrared detecting device or 2) to predict road lane location, based on a path defined by the heat tracks detected by the infrared detecting device.

In accordance with another aspect of an embodiment, a method provides road condition data for a vehicle. The vehicle has a front, a rear, a right side and a left side. The method provides an infrared detecting device on the front of the vehicle. Variations in road temperature is detected with the infrared detecting device. Road conditions are predicted in a control unit based on the variations in road temperature detected by the infrared detecting device.

In accordance with yet another aspect of an embodiment, a method of provides lane assist for a vehicle. The method provides an infrared detecting device on a front of the vehicle. Heat tracks left on a road lane by preceding vehicles are detected with the infrared detecting device. Road lane location is predicted by a control unit based on a path defined by the heat tracks detected by the infrared detecting device.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a plan view of a vehicle equipped with an advanced driver assist or autonomous vehicle system for determining road condition in accordance with an embodiment of the invention.

FIG. 2 is a schematic view of the system of FIG. 1.

FIG. 3 is a plan view of a vehicle equipped with an advanced driver assist or autonomous vehicle system for lane assist in accordance with another aspect of the invention.

### DETAILED DESCRIPTION OF EXEMPLARY EMBODIMENTS

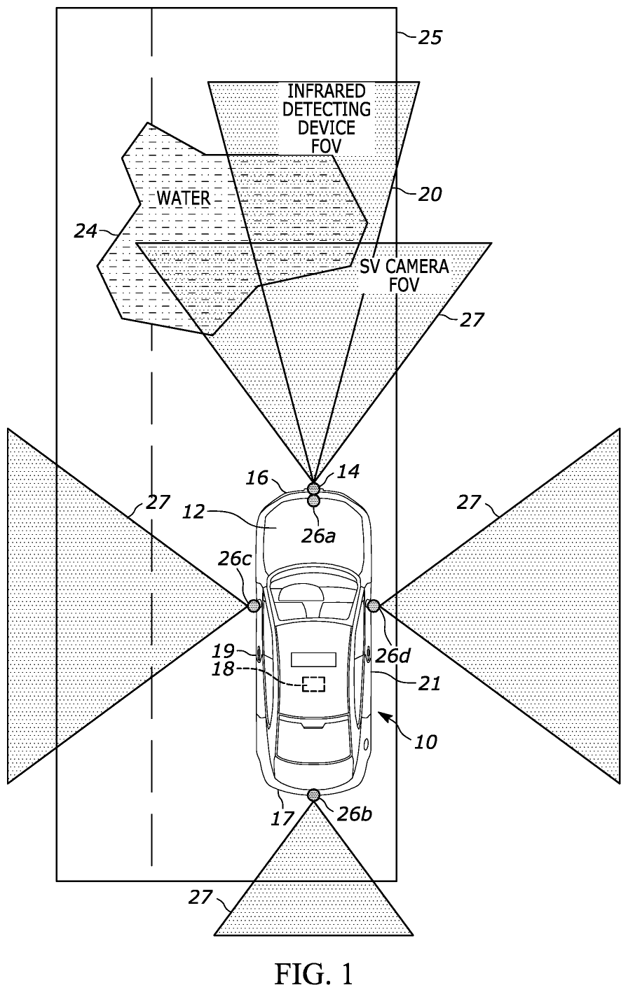

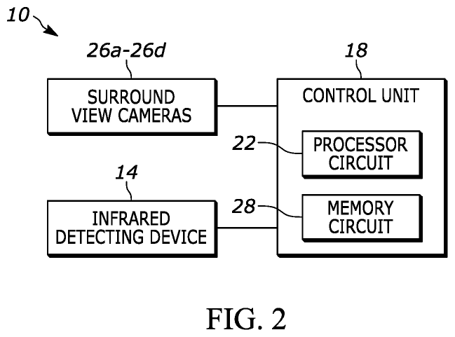

With reference to FIG. 1, an advanced driver assist or autonomous vehicle system is shown, generally indicated at 10, for a vehicle 12 in accordance with an embodiment. The system 10 includes an infrared measuring device 14, preferably mounted on the front 16 of the vehicle 12, such as on or in the grill or front bumper. As best shown in FIG. 2, the system also includes a control unit 18 mounted in the vehicle 12 and connected to the infrared detecting device 14 so as to process signals received from the infrared detecting device 14. The infrared detecting device's field of view (FOV) in front of the vehicle 10 is shown at 20.

In the embodiment, the infrared (IR) detecting device 14 comprises an infrared camera or a thermal imaging camera. The infrared camera typically uses short wavelength infrared light to illuminate an area of interest. Some of the infrared energy is reflected back to the infrared camera and interpreted to generate an image data. A thermal imaging camera typically uses mid or long wavelength infrared energy. Thermal imaging cameras are passive, and only sense differences in heat. Thus, the infrared detecting device 14 can detect variations in road temperature (heat signature) without the presence of light. This allows algorithms, executed by the processor circuit 22 of the control unit 18, to use this temperature variation data to determine predictions of road conditions. As shown in FIG. 1, for example, the infrared detecting device 14 can identify that there is water 24 on the road 25, based on the infrared data. Thus, for example, the processor circuit 22 can execute an algorithm including the steps of receiving a heat signature of an object (e.g., water) on the road that has a heat signature different from a heat signature of surrounding areas on the road; comparing the received heat signal to known heat signals stored in a memory circuit 28; and predicting or identifying the type of object defining a road condition on the road based on the comparison. The output from the infrared road condition algorithm can then be compared to the output from the standard systems already present on the vehicle and these outputs can then be sent to the main computer system that is controlling the vehicle actuation for fusion.

The data provided by the infrared detecting device 14 can be used in collaboration with the data from a conventional surround view camera system having a plurality of normal (non IR) cameras 26a-26d, each configure to obtain an image. First camera 26a is located on the front 16 of the vehicle 12, second camera 26b is located on the rear 17 of the vehicle 12, third camera 26c is located on the left side 19 of the vehicle 12 and fourth camera 26d is located on the right side 21 of the vehicle 12. These cameras 26a-26d are typically mono cameras having a FOV 27 of up to 125 degrees or fish-eye cameras having a FOV greater than 180 degrees, which can be used at least for lane assist, parking assist, and emergency braking for crash avoidance. Cameras 26a-26d are connected to the control unit 18. Certain of the cameras 26a-26d can also be used for road condition observance, as disclosed Patent Application Publication US2018/0141561 A1, the content of which is hereby incorporated by reference herein. Thus, the light-reflective image capturing cameras 26a-26d, can provide image data to the control unit 18 regarding road conditions when sufficient light is available, with the infrared detecting device 14 providing thermal data regarding road conditions to the control unit 18 when sufficient light is unavailable. With such data, the control unit 18 or other vehicle controller can control various vehicle systems (e.g., vehicle braking, speed control, etc.) depending on the sensed or predicted road conditions. Memory circuit 28 of the control unit 18 can store the algorithms and/or data from the infrared detecting device 14, and cameras 26a-26d.

Thus, the infrared detecting device 14 can detect water, ice, or any lane irregularities much easier at night. The infrared detecting device 14 is able to determine road conditions based on variations in infrared readings across the road and these readings can then be compared to the output provided by the surround view cameras 26a-26d for improved accuracy. It can be appreciated that the control unit 18 can receive data other than from just the infrared detecting device 14 and/or the cameras 26a-26d, such as outside temperature, humidity, wind speed data, whether the vehicle wipers are on, etc. for use in predicting road conditions. Also, the infrared detecting device 14 can be always on, or can be activated based on an ambient light sensors (e.g., the conventional light sensor that can automatically turn on the vehicle's lights as daylight fades).

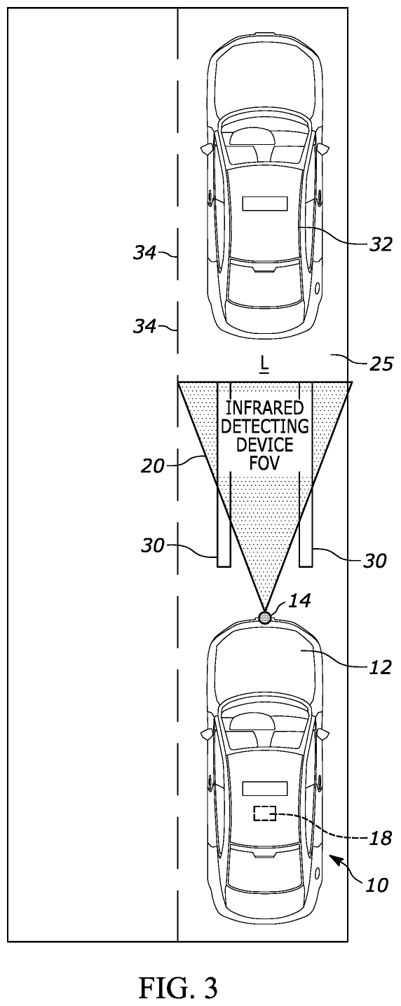

With reference to FIG. 3, the infrared detecting device 14 can be employed in a lane assist application by detecting heat tracks 30 on a road lane L left by another vehicle 30 or vehicles preceding the vehicle 12 traveling down the road 25. The heat from the tires of a vehicle 32 driving on the road creates a trail behind the vehicle 32. With multiple vehicles driving in the same road lane L, specific portions of the road lane L are warmer than others. High traffic and higher speed roads will provide better heat tracks 30 to follow.

The processor circuit 22 of the control unit 18 can execute an algorithm to predict the road lane L location, based on the path most traveled by the other vehicles 32. For example, the processor circuit 22 can execute an algorithm including the steps of receiving a heat signature of heat tracks 30 on the road that have a heat signature different from a heat signature of surrounding areas on the road; and calculating or predicting a lane location L on the road based on the location of the heat tracks 30. If the driver deviates from the lane L, the control unit 18 can activate a warning signal or can cause automatic control of the steering to bring the vehicle back into the lane. Alternatively, the output from the infrared lane assist algorithm can then be compared to the output from the standard systems already present on the vehicle and these outputs can then be sent to the main computer system that is controlling the vehicle actuation for fusion.

The use of the infrared detecting device 14 reduces the need for quality lane markers 34 that are employed in conventional lane keeping technologies. The infrared detecting device 14 should be mounted to the front of the vehicle 12 as close to the road as possible. Infrared detecting device 14 can be used alone, or in conjunction with the surround view cameras 26a-26d of FIG. 1 that can provide data on the location of the lane markers 34. Thus, the infrared detecting device 14 can be used to enhance or as a backup to the regular lane marker detection system (e.g., mono-cameras) that is used for conventional lane assist. When lane markers 34 are unable to be detected by certain of the mono cameras 26a-26d due to poor lighting or lack of paint, the infrared detecting device 14 can use the heat tracks 30 from other vehicles as a reference to where the lane L should be.

The operations and algorithms described herein can be implemented as executable code within a micro-controller or control unit 18 having processor circuit 22 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein.

Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 28 can be implemented, for example, using a non-volatile memory such as a programmable read only memory (PROM) or an EPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A system for a vehicle, the vehicle having a front, a rear, a right side and a left side, the system comprising:
an infrared detecting device mounted on the front of the vehicle, the infrared detecting device being constructed and arranged to 1) detect variations in road temperature and 2) detect heat tracks left on a road lane by preceding vehicles, and
control unit mounted in the vehicle and connected to the infrared detecting device so as to process signals received from the infrared detecting device, the control unit being constructed and arranged 1) to predict road conditions based on the variations in road temperature detected by the infrared detecting device or 2) to predict road lane location, based on a path defined by the heat tracks detected by the infrared detecting device.

2. The system of claim 1, wherein the infrared detecting device is an infrared camera.

3. The system of claim 1, wherein the infrared detecting device is a thermal imaging camera.

4. The system of claim 1, wherein the control unit includes a processor circuit constructed and arranged to execute algorithms to predict the road conditions or to predict the road lane location.

5. The system of claim 4, wherein the processor circuit is constructed and arranged to execute the algorithm including the steps of receiving a heat signature of an object on the road that has a heat signature different from a heat signature of surrounding areas on the road; comparing the received heat signal to known heat signals stored in a memory circuit; and predicting or identifying the type of object defining a road condition on the road based on the comparison.

6. The system of claim 4, the processor circuit 22 is constructed and arranged to execute an algorithm including the steps of receiving a heat signature of heat tracks on the road that have a heat signature different from a heat signature of surrounding areas on the road, and calculating or predicting a lane location on the road based on the location of the heat tracks.

7. The system of claim 1, further comprising:
a first camera mounted on the front of the vehicle,
a second camera mounted on the rear of the vehicle,
a third camera mounted on the left side of the vehicle, and
a fourth camera mounted on the right side of the vehicle,
wherein the first, second, third and fourth cameras define image capturing cameras and are each connected with the control unit such that the infrared detecting device in conjunction with certain of the image capturing cameras can 1) provide image data to the control unit regarding road conditions when sufficient light is available, and the infrared detecting device can provide thermal data to the control unit regarding road conditions when sufficient light is unavailable, or 2) to provide lane assist data based on the detected heat tracks alone or in conjunction with image data from the cameras.

8. The system of claim 7, wherein each of first, second, third and fourth camera is a mono camera having a field of view of up to 125 degrees.

9. The system of claim 7, wherein each of first, second, third and fourth camera is a fish-eye camera having a field of view greater than 180 degrees.

10. The system of claim 7, wherein certain of the first, second, third and fourth cameras are configured to detect road lane markers.

11. The system of claim 7, wherein certain of the first, second, third and fourth cameras are configured to detect reflection of light on the road.

12. A method of providing road condition data for a vehicle, the vehicle having a front, a rear, a right side and a left side, the method comprising:
providing an infrared detecting device on the front of the vehicle,
detecting, with the infrared detecting device, variations in road temperature, and
predicting, in a control unit, road conditions based on the variations in road temperature detected by the infrared detecting device.

13. The method of claim 12, wherein the infrared detecting device is provided as an infrared camera.

14. The method of claim 12, wherein the infrared detecting device is provided as a thermal imaging camera.

15. The method of claim 12, wherein the control unit includes a processor circuit and the method further comprises:
executing, via the processor circuit, an algorithm to predict the road conditions by receiving a heat signature of an object on the road that has a heat signature different from a heat signature of surrounding areas on the road;
comparing the received heat signal to known heat signals stored in a memory circuit; and predicting or identifying the type of object defining a road condition on the road based on the comparison.

16. The method of claim 12, further comprising:
providing a first camera mounted on the front of the vehicle,
providing a second camera mounted on the rear of the vehicle,
providing a third camera mounted on the left side of the vehicle,
providing a fourth camera mounted on the right side of the vehicle,
wherein the first, second, third and fourth cameras define image capturing cameras and are each connected with the control unit,
providing, via certain of the image capturing cameras, image data to the control unit regarding road conditions when sufficient light is available, and
providing, with the infrared detecting device, thermal data to the control unit regarding road conditions when sufficient light is unavailable.

17. A method of providing lane assist for a vehicle, the vehicle having a front, a rear, a right side and a left side, the method comprising:
providing an infrared detecting device on the front of the vehicle, detecting, with the infrared detecting device, heat tracks left on a road lane by preceding vehicles, and
predicting, in a control unit, road lane location, based on a path defined by the heat tracks detected by the infrared detecting device.

18. The method of claim 17, wherein the infrared detecting device is provided as an infrared camera.

19. The method of claim 17, wherein the infrared detecting device is provided as a thermal imaging camera.

20. The method of claim 17, wherein the control unit includes a processor circuit and the method further comprises:
executing, via the processor circuit, an algorithm to receiving a heat signature of the heat tracks on the road that have a heat signature different from a heat signature of surrounding areas on the road, and calculating or predicting a lane location on the road based on the location of the heat tracks.
